(19) United States
(12) Patent Application Publication
(10) Pub. No.: US 2006/0170417 A1
(43) Pub. Date: Aug. 3, 2006

(54) Distributed array magnetic tracking

(76) Inventors: Allan G. Rodgers, Jericho, VT (US); Robert F. Higgins, Richmond, VT (US); Keith M. Hanf, Fairfax, VT (US); James C. Farr, St. Albans, VT (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/339,286

(22) Filed: Jan. 25, 2006

Related U.S. Application Data
(60) Provisional application No. 60/649,193, filed on Feb. 2, 2005.

(51) Int. Cl. G01B 7/30

(52) U.S. Cl. 324/207.17

(57) ABSTRACT

Magnetic tracking systems and methods confine source(s)/sensor(s) to a compact region, thereby facilitating enhanced precision without the need for distortion compensation or mapping. Several sensors placed in accurately known (or determined through algorithms within the tracker processor) locations allow a single small magnetic field source to be tracked by all of them simultaneously. Such a configuration allows an operator's head to be tracked accurately, as in a flight simulator, where coupling between field source and sensors is kept short, thereby eliminating the need for distortion mapping.

### REFERENCE TO RELATED APPLICATION

This application claims priority from U.S. Provisional Patent Application Ser. No. 60/649,193, filed Feb. 2, 2005, the entire content of which is incorporated herein by reference.

### FIELD OF THE INVENTION

This invention relates generally to magnetic tracking and, in particular, to a distributed array environment that facilitates enhanced precision without the need for distortion compensation or mapping.

### BACKGROUND OF THE INVENTION

One of the major drawbacks to utilizing magnetic trackers in such applications as aircraft simulators is the issue of distortion of the magnetic fields caused by the induction of eddy currents into nearby conducting metals. Since the use of good conductors such as aluminum is prevalent in the aircraft industry and other applications, the problem of distortion is a serious drawback to taking advantage of the reliability, maturity, speed, accuracy and compact size of magnetic trackers.

Methods for dealing with distortion have long been available. However, the cost of performing a precise mapping of the distortion so it can be compensated out of the tracker often results in several times the cost of the tracker itself; in addition, the asset being mapped is out of use for one to two weeks during the process. Consequently, there is a need for a system and method that can bypass the requirement for mapping in most situations.

Typical AC magnetic trackers operate with a magnetic field source in a fixed position. Fields from this source are coupled to one or more sensors which can then be tracked in the immediate volume nearby. Conceptually speaking, this is perhaps the easiest configuration to understand because all position and orientation (P&O) tracking results can be referenced to the source position. The addition of more sensors (e.g. to track hand motions as well as the head) is thus quite straightforward.

Theoretically, the calculations of P&O between source and sensor are entirely reciprocal such that a sensor, or sensors, could be held static while the field source(s) is moved about and tracked. The position and orientation of one of the sensors, or even an arbitrary point in the environment, can be used as the geometric reference point for all tracking measurements. The capability for doing this “reverse tracking” through a sensor reference point in an environment is taught in commonly assigned U.S. Provisional Patent Application Ser. No. 60/598,709, the entire content of which is incorporated herein by reference.

The AC magnetic tracker block diagram shown in FIG. 1 depicts how orthogonal coils in the source (1) couple signals to the orthogonal coils of a sensor (2). Orthogonality is not a strict requirement nor is it a limitation of a single source and/or a single sensor. The typical AC magnetic tracker has a single source and at least one sensor, but many more sensors typically are added. The processor (3) controls the tracking activity and reports out to a host computer the position and orientation of the sensor(s) relative to the source.

Reciprocity allows this process to be reversed to yield the source position relative to a sensor. Additional mathematical algorithms allow the use of multiple sensors and referencing all P&O results to either one of the sensors or to another location in the environment. These capabilities, and also accommodation of multiple sources as long as their operating frequencies are distinguishable, are taught in U.S. patent application Ser. Nos. 11/147,977 and 11/207,098, the entire content of each being incorporated herein by reference.

In general, prior-art AC magnetic trackers attempt to cover large areas, minimizing distortion effects with relatively little concern for high accuracy. Although it may be advantageous to minimize source-sensor coupling distance and use multiple sensor responses to participate in solutions, previous applications exhibit reasonable accuracy over an area much larger than possible to achieve signal coupling from a single reference point relative to a distant signal source, referencing the result to a distant reference sensor.

### SUMMARY OF THE INVENTION

This invention broadly resides in magnetic tracking systems and methods that concentrate source(s)/sensor(s) in a compact region, thereby facilitating enhanced precision without the need for distortion compensation or mapping. According to the invention, several sensors can be placed in accurately known (or determined through algorithms within the tracker processor) locations so that a single small magnetic field source can be tracked by all of them simultaneously. This allows participation of all such results in determining one final P&O answer to do two things: 1) Improve tracking accuracy, and 2) Maintain close coupling relative to any nearby conductors that could cause eddy current field distortion.

In the preferred embodiment, an array of 3-axis sensors is used to track the position and orientation of a small 3-axis field source. This might be considered a ‘reverse’ tracking system compared to typical trackers which use a single source to provide tracking of multiple sensors. However, since the tracking process is entirely reciprocal, in alternative embodiments multiple sensors can be used to track a source(s). It also is possible, though less desirable, to use an array of distinct sources to a single sensor. The invention is also applicable to both AC and DC tracking systems, but if DC tracking is used, one can have multiple sensors reverse-tracking a single source but cannot have multiple DC source tracking even a single sensor because thay cannot be distinguished.

By virtue of the invention, an array of sensors can be employed to 1) Achieve high-gain, high-precision accuracy of a small field source, such as on a helmet, eyepiece display, hand tool, or surgeon's instrument; 2) Operate where source-sensor coupling remains small as the source navigates a region covered by an array of sensors, thereby virtually eliminating the effects of eddy current distortion without resorting to complex and expensive compensation procedures; 3) Automatically produce the best answer possible by algorithms that account for range and distortion indications to use the proper sensor measurements in the overall P&O result; and 4) Be less sensitive to interference within the helmet or other sub-system on which it may be mounted by generating signals rather than sensing very small ones.

### BRIEF DESCRIPTION OF THE DRAWINGS

FIG. 1 is a depiction of a typical configuration of an AC magnetic tracker;

FIG. 2 shows source and sensors according to the invention; and

FIG. 3 shows possible motion box relationships.

### DETAILED DESCRIPTION OF THE INVENTION

This invention broadly resides in magnetic tracking systems that concentrate source(s)/sensor(s) in a compact region, facilitating enhanced precision without the need for distortion compensation or mapping. In the preferred embodiment, multiple sensors are used to track a moving source. The use of multiple sensors merged into a single tracking solution improves accuracy well beyond that of an unmapped volume, and the distribution of several sensors allows operating in a reasonable range larger than would be the case with a single sensor, particularly when all sensors are within coupling range and contribute to the position and orientation (P&O) result.

The system, referred to as DARTT (Distributed ARray Tracking Technology), improves upon certain existing capabilities, including: 1) Establishing a single reference point for source tracking when using multiple sensors (U.S. patent application Ser. No. 11/147,977, the entire content of which is incorporated herein by reference) or multiple sources (U.S. patent application Ser. No. 11/207,098, the entire content of which is incorporated herein by reference) and 2) Locating for reference the various sensors when preparing the framework.

In contrast to existing arrangements, however, the invention concentrates the tracking source(s) and sensors in a compact region, achieving greater precision without distortion compensation. Source-sensor distances are kept short to minimize outside influences, and this is done with the lowest amount of signal possible. The ability to string several small sensors near an aviator's head in a simulator, for instance, allows the system to monitor a small signal source on his head/helmet.

The source to be tracked in the DARTT can be tethered or untethered (i.e., cabled or wireless battery operation). If tethered, the tracking system electronics unit is continuously in control of generated signal level, synchronization, calibration, etc. in the normal tracker fashion, the only change being the reversal of typical roles for source and sensor. If untethered, the signal source can be detected and located by the sensor(s) as described in U.S. patent application Ser. No. 11/147,977, incorporated herein by reference, which discusses wireless sources, and synchronized with sensor operation as taught in U.S. Provisional patent application Ser. No. 11/147,888 incorporated herein by reference, which describes synchronizing to non-coherent sources.

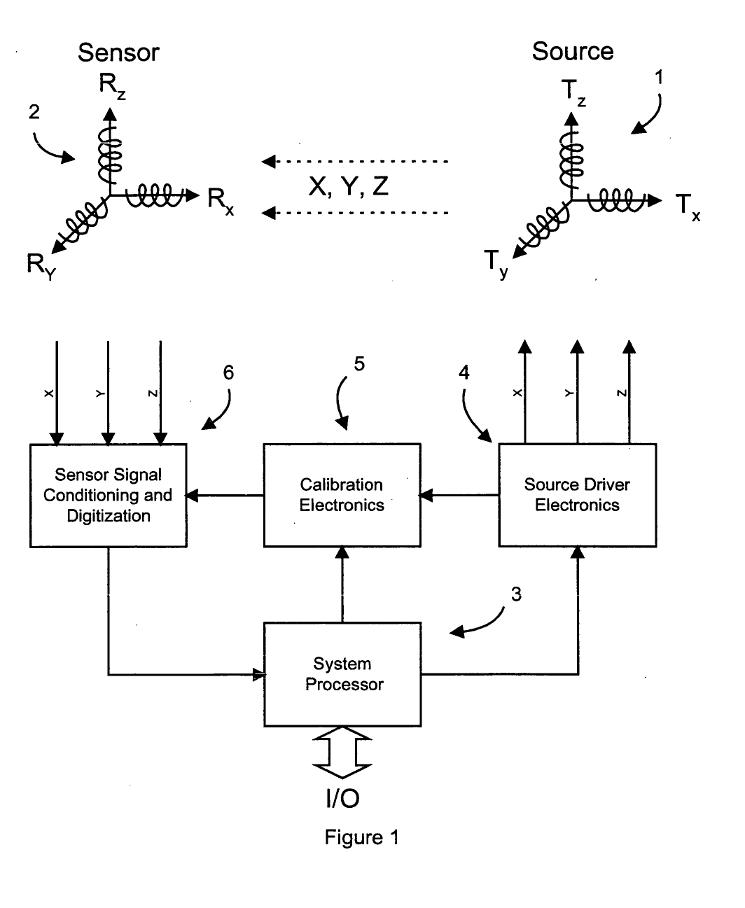

The most often used technology for 3D head/helmet tracking has been AC magnetics where a field source (1) couples signals to at least one sensor (2) (see FIG. 1). Use of a dipole field model allows producing both position and orientation (P&O) of the sensor with a single data sample. In actuality, the P&O is a relative computation between source and sensor such that reciprocity holds true and it makes no difference which device is being tracked from the other as a reference.

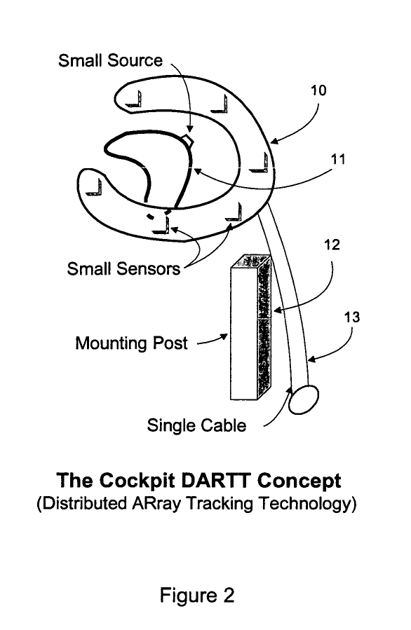

The arrangement in FIG. 2 shows a grouping of magnetic field sensors (10) arranged on a bracket above the user's helmet which contains a small field source (11). For convenience, a special cable (13) could combine all the sensor connections along a mounting post (12) for connection to the tracker system electronics unit (SEU). The mounting post is depicted as a simple rectangular bar without connections since each and every application will need a mounting post and attachments specifically designed for that application. Another small cable would need to be connected over the body of the user to drive the small source on the helmet, or a battery driven circuit module could be used independent of the SEU. The most preferred configuration would be to have it cabled to the SEU, which happens to have an advantage over typical applications where the sensor is on the helmet. Substitution of the source means that strong drive signals will go to the helmet, where various interfering signals typically are present, which is a decided advantage over a sensor conducting off the helmet very low level signals, which easily can be compromised.

When operating in a confined region device coil apertures could be a problem, but this is solved by using a source and sensors of small size, as shown in FIG. 2. Although algorithms are readily available to approximate aperture effects, it is best to eliminate the problem where possible. Another minor item is the need to change the cockpit boresighting function, which aligns the helmet with other systems, from a sensor to a source, which can be handled quite easily mathematically in the tracker. Only two issues remain: 1) Combining the P&O results received from each sensor in the way (straight average, weighted based on range to source, etc.) that produces the most accurate composite answer, and 2) Determining the least number of sensors and their geometry for achieving the desired results.

Two effects come into play when combining P&O results and considering the range, r, separating a specific source-sensor pair: 1) The signal-to-noise ratio (SNR) in the signal coupling, which decreases by 1/r³, and 2) The effect of distortion which, for a given type and shape distorter, tends to nonlinearly affect the result when separation distance, d, becomes less than 2r (that is d<2r, or r>d/2). Because the overall DARTT concept is aimed squarely at minimizing the effects of distortion, the second item deserves considerable attention. The SNR argument is much easier to deal with and can be managed reliably by weighting the result of a particular source-sensor pair practically to zero when separation reaches a certain threshold (typically can be set to 12″-15″; 30 cm-38 cm for standard devices) unless all source-sensor pairs are past such a threshold, in which case all must be used in an attempt to minimize noise effects unless another criterion, such as distortion, dominates. Nevertheless, long range accuracy will suffer, but use of many sensor results can make this less severe.

Distortion effects typically starting at r>d/2 require more attention. Polhemus has developed an algorithm which we call a “distortion alarm” that can be put to use here. Consequently, a detailed description of how the distortion alarm works follows below. The P&O algorithm uses a dipole field model. As such, computations on the position vectors and the measurements collected should reconcile closely.

The distortion alarm (DA) consists of subtracting the value of the sensor signal matrix from the position measure, which should be zero in the ideal situation. As distortion is encountered, a growing difference becomes a measure of the growing uncertainty in the P&O result. Hence, a small threshold value can be set to determine if distortion is present. In equations,
|kRR^{T}+I−S^{T}S|=δ< distortion threshold,
where k=constant,
R=position vector,
I=unity matrix,
S=signal matrix,

| |signifies the Euclidian norm, and
^{T} signifies matrix transpose.

Use of the DA in the DARTT algorithm for determining P&O of the small field source is as follows: 1) For the P&O solution of each source-sensor pair the answer can participate in the final P&O result only if the DA does not occur, and 2) If all solutions indicate distortion, then no final P&O result should be provided. This is analogous to tracking with optical techniques where no result can be given if the light is blocked.

The number of sensors in the DARTT array plus their geometry remains to be discussed. If two sensors are used and the range to them is the same, accuracy should be improved by the number of participating sensors. In this case, 1/√2=0.707 of the single sensor error. If three sensors under the same conditions, 1/√3=0.577. Four sensors would be 1/√4=0.5, again if all conditions are the same. Of course the case where all sensors in the array are at the same range is a rare situation. Nonetheless, the trend certainly is evident that one extra sensor can make a 30 percent improvement, two extra about 42 percent and three 50 percent, each additional sensor contributing less. However, the use of multiple sensors allows some extension in range so that in the worst case if all but one sensor in the array are out of range, then the worst accuracy performance would be that of a single source-sensor pair in the limit.

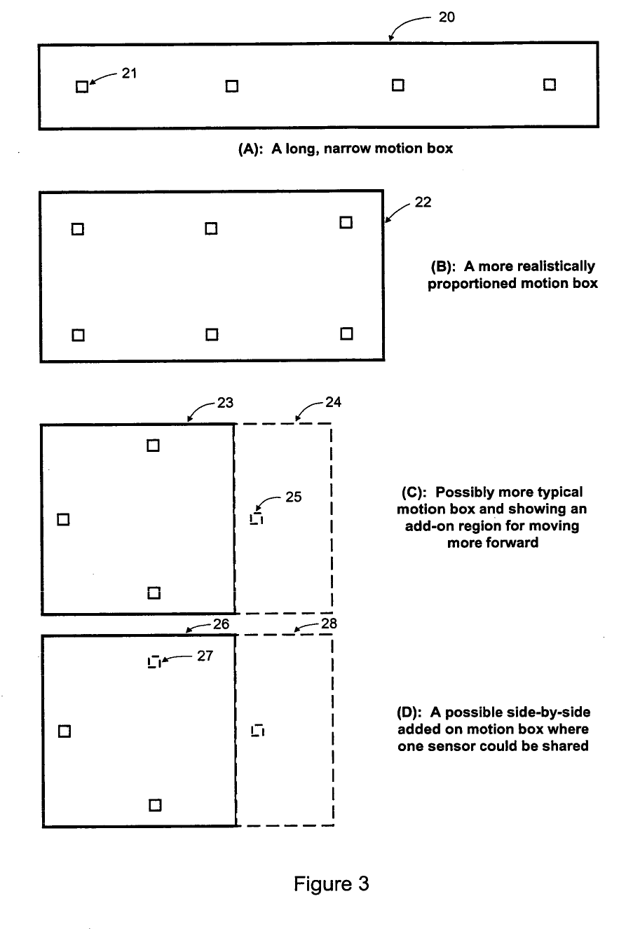

Perhaps this can be better understood by referring to FIG. 3. The (A) motion box geometry (20) is aimed at a fore-aft emphasis where the DARTT sensors (21) are arranged in a simple line, yielding a motion box width of perhaps ±8″-10″. Here, the extension of range without distortion is the primary concern. The (B) motion box geometry (22) consumes more sensors but allows more side-to-side tracking. Here, range is extended but so, too, are contributions from multiple sensors to enhance tracking accuracy. The (C) motion box (23) is a realistic approach where only three sensors could yield good side-to-side motion and could add fore-aft space (24) by adding another DARTT sensor (25). This allows a reasonable size to the motion box for range but allows multiple sensors to participate in accuracy in the region where a source (and helmet) may be confined most of the time in a flight simulator. For a side-by-side cockpit motion box, (D) added to (C), it may be possible to share a sensor and not use the one shown at (27). Forward extension (28) could match the geometry in (C). Of course, the actual number of sensors used depends on accuracy and distortion tolerance goals.

We claim:

1. A magnetic tracking system, comprising:
a magnetic source supported on an object to be tracked in a motion box;
a plurality of magnetic field sensors supported in accurately known, fixed locations close to the source; and
a processor in communication with the source and sensors, the processor being operative to determine the position and orientation (P&O) of the source using results associated with each source-sensor pair simultaneously.

2. The system of claim 1, wherein sensor locations are physically predetermined.

3. The system of claim 1, wherein sensor locations are computed by the processor.

4. The system of claim 1, wherein the electronics connection to the source is wired or wireless.

5. The system of claim 1, wherein the source and sensors are sufficiently small to eliminate device coil apertures.

6. The system of claim 1, wherein the processor is further operative to use a subset of source-sensor results based upon the range, r, separating each source-sensor pair.

7. The system of claim 1, wherein the processor is further operative to disregard the result of a particular source-sensor pair if the range, r, separating that source-sensor pair reaches a predetermined threshold.

8. The system of claim 1, wherein the processor is further operative to use the results of all source-sensor pairs if the range, r, separating each source-sensor pair reaches a predetermined threshold.

9. The system of claim 1, wherein the processor is further operative to disregard the result of a particular source-sensor pair if the range, r, separating that source-sensor pair is greater than d/2, where “d” is the distance to a distorter.

10. The system of claim 1, wherein the processor is further operative to:
subtract the value of the sensor signal matrix from the position measure for each source-sensor pair associated with the P&O solution; and
disregard the result associated with that pair if the difference is greater than a predetermined threshold.

11. The system of claim 1, wherein the processor is further operative to:
subtract the value of the sensor signal matrix from the position measure for each source-sensor pair associated with the P&O solution; and
withhold an overall P&O result if the differences associated with all of the pairs are greater than a predetermined threshold.

12. The system of claim 1, wherein the source is supported on a helmet or other head-worn implement.

13. The system of claim 1, wherein the source is supported on a tool or surgical instrument.

14. The system of claim 1, wherein the sensors are supported in a linear array.

15. The system of claim 1, wherein the sensors are supported in a rectangular matrix.

16. The system of claim 1, wherein the sensors are supported in an arbitrary arrangement.

17. The system of claim 1, wherein the source and sensors incorporate orthogonal, 3-axis coils.

18. The system of claim 1, wherein the roles of the source and sensors are reversed.

19. The system of claim 1, wherein at least one of the sensors or an arbitrary position is used as a reference for source tracking or boresighting.

20. A magnetic tracking method, comprising the steps of:
supporting a magnetic source on an object to be tracked in a motion box;
supporting a plurality of magnetic field sensors in accurately known, fixed locations close to the source; and
determining the position and orientation (P&O) of the source using results associated with each source-sensor pair simultaneously.

21. The method of claim 20, wherein sensor locations are predetermined or known in advance.

22. The method of claim 20, wherein sensor location is computed by the processor.

23. The method of claim 20, wherein the sensors are in wired or wireless communication with the source.

24. The method of claim 20, wherein the source and sensors are sufficiently small to eliminate device coil apertures.

25. The method of claim 20, further including the step of using a subset of source-sensor results based upon the range, r, separating each source-sensor pair.

26. The method of claim 20, further including the step of disregarding the result of a particular source-sensor pair if the range, r, separating that source-sensor pair reaches a predetermined threshold.

27. The method of claim 20, further including the step of using the results of all source-sensor pairs if the range, r, separating each source-sensor pair reaches a predetermined threshold.

28. The method of claim 20, further including the step of disregarding the result of a particular source-sensor pair if the range, r, separating that source-sensor pair is greater than d/2, where “d” is the distance to a distorter.

29. The method of claim 20, further including the steps of:
subtracting the value of the sensor signal matrix from the position measure for each source-sensor pair associated with the P&O solution; and
disregarding the result associated with that pair if the difference is greater than a predetermined threshold.

30. The method of claim 20, further including the steps of:
subtracting the value of the sensor signal matrix from the position measure for each source-sensor pair associated with the P&O solution; and
withholding an overall P&O result if the differences associated with all of the pairs are greater than a predetermined threshold.

31. The method of claim 20, wherein the sensors are supported in a linear array.

32. The method of claim 20, wherein the sensors are supported in a rectangular matrix.

33. The method of claim 20, wherein the sensors are supported in an arbitrary arrangement.

34. The method of claim 20, wherein the source and sensors incorporate orthogonal, 3-axis coils.

35. The method of claim 20, wherein the roles of the source and sensors are reversed.

36. The method of claim 20, wherein at least one of the sensors or an arbitrary position is used as a reference for source tracking or boresighting.
